(19) United States
(12) Patent Application Publication
(10) Pub. No.: US 2025/0345957 A1
(43) Pub. Date: Nov. 13, 2025

(54) OUT-THE-FRONT KNIFE

(71) Applicant: Kevin Michael Sayers, Sevierville, TN (US)

(72) Inventor: Kevin Michael Sayers, Sevierville, TN (US)

(21) Appl. No.: 18/954,821

(22) Filed: Nov. 21, 2024

Related U.S. Application Data
(60) Provisional application No. 63/607,715, filed on Dec. 8, 2023.

(51) Int. Cl. B26B 5/00

(52) U.S. Cl. CPC B26B 5/003

(57) ABSTRACT

A knife is disclosed, comprising a base body and a slider body with a cavity therebetween, housing a shuttle carrying a knife blade. The shuttle includes a shuttle pin configured to engage the base or slider body, and a shuttle spring configured to bias the shuttle to a retracted position. A releasable lock, constrained between the shuttle and base body, locks the shuttle in an extended position, with a releasable lock spring biasing it towards the locked position. A shoulder on the slider body engages the releasable lock upon slider retraction, releasing it to allow the shuttle to retract. This design provides a secure and efficient mechanism for deploying and retracting the knife blade, enhancing user safety and convenience.

### CROSS-REFERENCE TO RELATED APPLICATIONS

This application claims benefit of the following patent application which is hereby incorporated by reference: U.S. Provisional Application No. 63/607,715 filed Dec. 8, 2023, entitled “Mechanism to actuate a blade.”

### BACKGROUND

### 1. Field of the Disclosure

The present disclosure relates generally to a knife. More specifically, the present disclosure relates to an out-the-front knife.

### 2. Description of the Prior Art

Various knife designs have been developed over the years to provide users with safe and efficient cutting tools for a wide range of applications. Traditional knives typically consist of a fixed blade or a folding blade mechanism, with the blade being manually extended and retracted by the user. While these designs have been effective in many situations, they may lack certain features that could enhance user experience and safety.

One approach to improving knife designs involves the use of retractable blades that are housed within a protective casing when not in use. These retractable knives often feature complex mechanisms that allow the blade to be extended and retracted with ease, providing convenience and safety for the user. However, existing retractable knife designs may still have limitations in terms of locking mechanisms and blade stability during use, which can impact the overall functionality and safety of the knife.

Another approach in knife design includes the incorporation of locking mechanisms to secure the blade in both extended and retracted positions. Locking mechanisms are crucial for preventing accidental blade deployment or retraction, thereby reducing the risk of injuries during handling and storage. While some knives on the market feature locking mechanisms, these mechanisms may not always provide a secure and reliable hold on the blade, leading to potential safety concerns for users. Additionally, existing locking mechanisms may lack user-friendly features that simplify the operation of the knife.

In summary, previous approaches to knife design have focused on incorporating retractable blades and locking mechanisms to enhance user safety and convenience. While these approaches have addressed certain aspects of knife functionality, there remains a need for a comprehensive solution that combines reliable blade locking, smooth blade deployment and retraction, and user-friendly operation. However, none of these approaches have provided a comprehensive solution that combines the features described in this disclosure.

### BRIEF SUMMARY

This Brief Summary is provided to introduce a selection of concepts in a simplified form that are further described below in the Detailed Description. This Brief Summary is not intended to identify key features or essential features of the claimed subject matter, nor is it intended to be used as an aid in determining the scope of the claimed subject matter.

The present disclosure is directed to a knife that includes a base body that is slidably connected to the slider body. The base body and the slider body define a cavity therebetween. The cavity houses a shuttle that is configured to carry a knife blade. A shuttle spring, releasable lock, releasable lock spring, and shuttle pin are also captured within the cavity between the base body and slider body.

By sliding the slider body in a direction relative to the base body, a user is able to extend and retract the knife blade. Sliding the slider body causes the shuttle pin to be engaged or disengaged to the slider body, depending on whether the user is attempting to extend or retract the blade. The shuttle spring biases the shuttle in the retracted direction such that when the releasable key is released to an unlocked position, the shuttle is moved toward a second end of the base body.

The knife blade is able to be removed and replaced. A user achieves this by extending the blade with the aforementioned steps. Next, the user simultaneously slides the slider body toward the second end of the base body while preventing the knife blade and shuttle from retracting. This may be achieved by grasping the knife blade and preventing it from retracting. These movements cause the shuttle pin to disengage from the slider body and allow the slider body to slide in the longitudinal direction toward a first end of the base body until it is no longer connected to the base body. The knife blade may then be removed and replaced. To reengage the slider body and the base body, the slider body is slid longitudinally toward the second end of the base body until a shoulder of the slider body engages the releasable lock and moves the releasable lock to the unlocked position. The knife blade is then retracted, and the knife is reset for purposes of extending and retracting the blade.

Numerous objects, features and advantages of the present invention will be readily apparent to those skilled in the art upon a review of the following description in conjunction with the accompanying drawings.

### BRIEF DESCRIPTION OF THE DRAWINGS

FIG. 1A is an isometric view of the out-the-front knife in the retracted position with the base body facing forward.

FIG. 1B is an isometric view of the out-the-front knife in the retracted position with the slider body facing forward.

FIG. 2 is an isometric view of the out-the-front knife in the extended position.

FIG. 3A is an exploded, isometric view of the out-the-front knife with the base body facing forward.

FIG. 3B is an exploded, isometric view of the out-the-front knife with the slider body facing forward.

FIG. 4 is an isometric view of one side of the shuttle showing the area where the knife blade may be secured.

FIG. 5 is an isometric view of the other side of the shuttle showing the shuttle spring.

FIG. 6 is an isometric view of the inside of the slider body.

FIG. 7A is an isometric view of the inside of the base body with the second end of the base body facing forward.

FIG. 7B is an isometric view of the inside of the base body with the first end of the base body facing forward.

FIG. 8 is an isometric view of the out-the-front knife in the extended position with the slider body removed.

FIG. 9 is an isometric view of the out-the-front knife in the retracted position with the slider body removed.

FIG. 10 is an isometric view of the out-the-front knife in the extended position with the slider body and the knife blade removed.

FIG. 11 is an isometric view of the out-the-front knife in the retracted position with the slider body and the knife blade removed.

FIG. 12 is a side elevation view of the out-the-front knife showing section 12.

FIG. 13 is a front elevation, section view of the out-the-front knife showing the cavity.

### DETAILED DESCRIPTION

Reference will now be made in detail to embodiments of the present disclosure, one or more drawings of which are set forth therein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof. Furthermore, any part of the apparatus of the present disclosure may be made using any applicable manufacturing method, such as, but not limited to 3D printing, injection molding, or the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

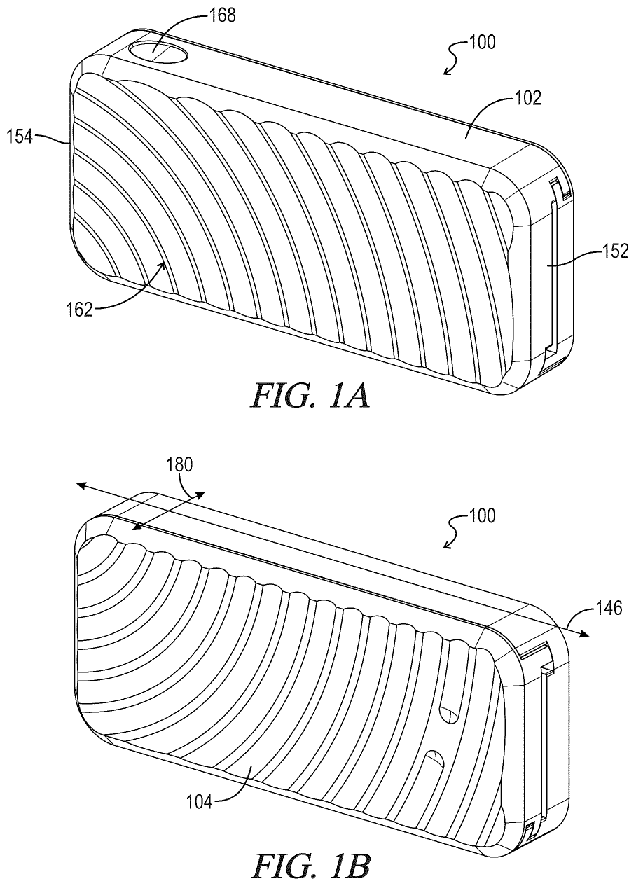

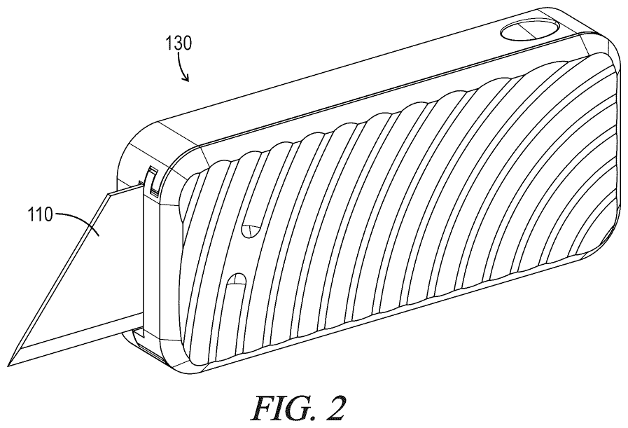

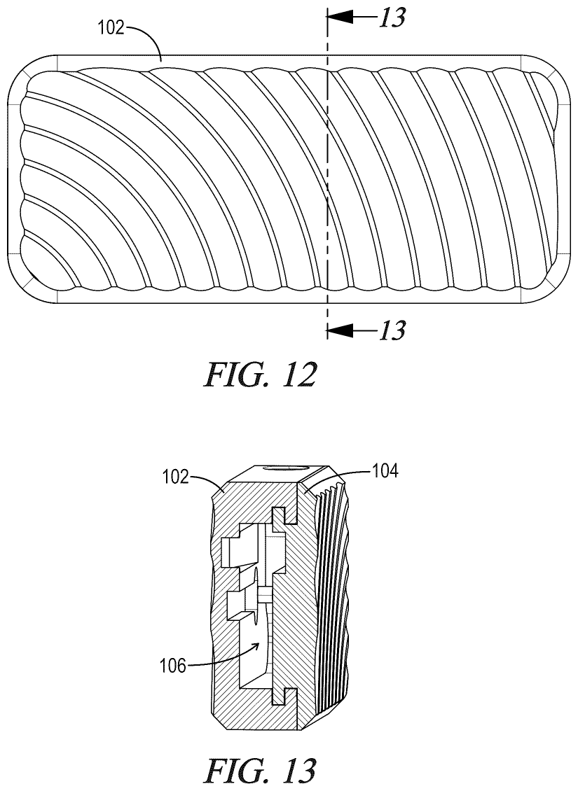

Referring now to FIGS. 1-13, an out-the-front knife 100 is provided. The out-the-front knife 100 may also be referred to herein as a knife 100. The out-the-front knife 100 includes a base body 102, a slider body 104, a shuttle 108, a shuttle pin 112, a shuttle spring 114, a releasable lock 122, and a releasable lock spring 132.

The base body 102 is coupled to the slider body 104. More particularly, the base body 102 may be slidably connected to the slider body 104. The base body 102 and the slider body 104 may be colinear. The base body 102 and the slider body 104 may define a cavity 106 between the base body 102 and the slider body 104. The base body 102 and the slider body 104 may be substantially rectangular in shape and have rounded edges to facilitate more comfortable use and storage.

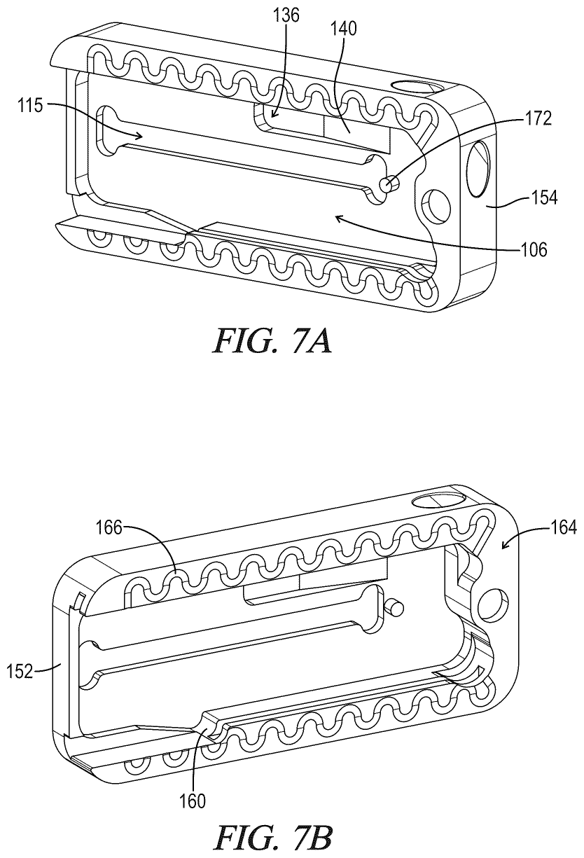

As shown in FIGS. 7A and 7B, the base body 102 may contain a base groove 136 and the slider body 104 may contain a slider groove 138. In these embodiments, the base groove 136 and a slider cam 142 may be configured to selectively engage the shuttle pin 112 to selectively move the shuttle 108 toward the extended position 130 or the retracted position 120. The base groove 136 may have an end with a flat bottom located toward a first end 152 of the base body 102, and the slider groove 138 may have an end with a flat bottom located toward a second end 154 of the base body 102. The ends of the base groove 136 and the slider groove 138 opposite the flat-bottom ends may be sloped. The sloped ends may be referred to herein as a base cam 140 and a slider cam 142, respectively.

As shown in FIGS. 1-2, the largest exterior surface of the base body 102 and the slider body 104 may be textured. The inclusion of texture 162 may provide a number of benefits including without limitation enhanced safety and visual appearance. By texturing the largest exterior surface of the base body 102 and the slider body 104, a user's hand is less likely to slip and cause injury than if the surface of the base body 102 and slider body 104 was smooth. For instance, a knurled texture 162 on the surface of the base body 102 and slider body 104 may increase the amount of surface area of the largest exterior surface of the base body 102 and slider body 104 such that there is an increased amount of friction between the face of the base body 102 and the slider body 104 and a user's hand. Other forms of texturing are known in the art and could be used.

As shown in FIGS. 7-11, the surface 164 of the base body 102 that engages the slider body 104 may be a low-friction surface 164. In particular, the surface 164 may contain an engraved pattern 166. This engraved pattern 166 may have a variety of benefits including without limitation aesthetic appeal and increased surface area for lubricant. The surface 164 of the base body 102 and the surface 164 of the slider body 104 are often in contact and may be a point where wear-and-tear could affect the overall functionality of the out-the-front knife 100. Therefore, applying a lubricant to this area would be beneficial as it could increase the lifespan of the out-the-front knife 100. In one embodiment of the present disclosure, the engraved pattern 166 on the surface 164 of the base body 102 that engages the surface 164 of the slider body 104 may be a serpentine pattern or other similar pattern that allows for increased surface area for lubricant to adhere to.

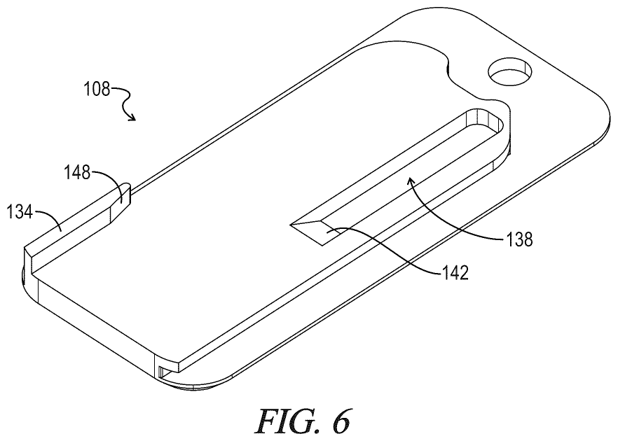

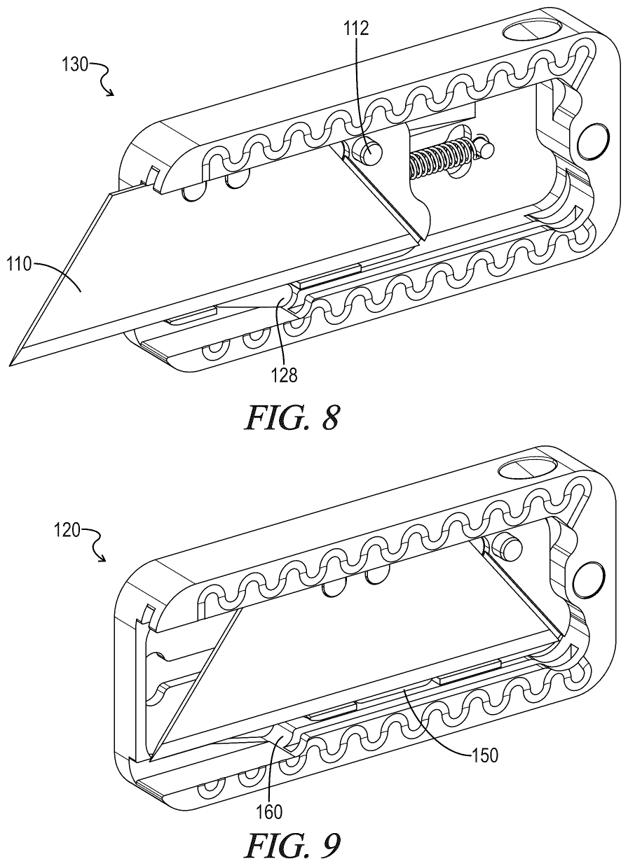

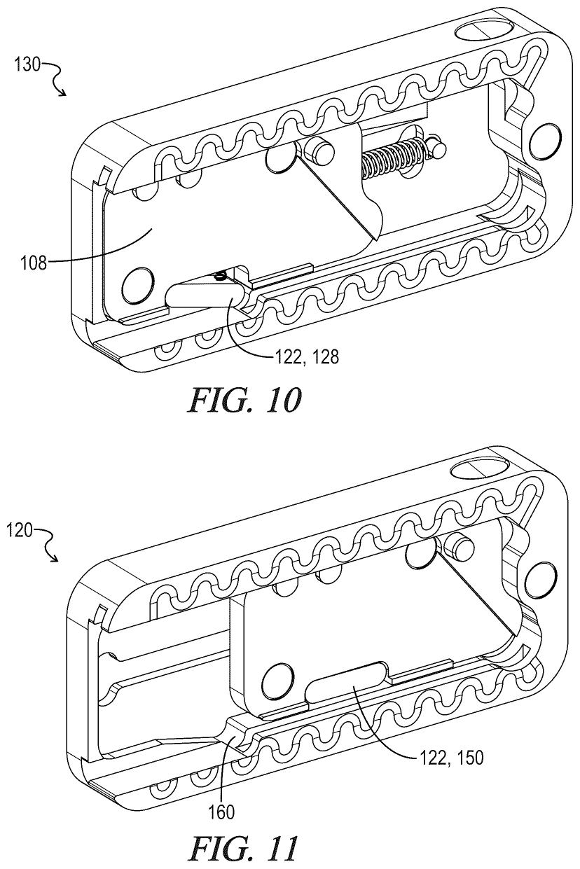

As shown in FIG. 6, the slider body 104 may include a shoulder 134. The shoulder 134 may extend from the slider body 104. The shoulder 134 may be configured to engage the releasable lock 122 when the out-the-front knife 100 is in the extended position 130 (see FIGS. 8 and 10) and the slider body 104 is moved in a longitudinal direction 146 toward the second end 154 of the base body 102. When the shoulder 134 engages the releasable lock 122 in this manner, a second releasable lock end 126 may be biased toward the shuttle 108 and be released from a ledge 160. The shuttle 108 may then be moved to the retracted position 120 (see FIG. 11) relative to the base body 102.

In certain optional embodiments, the releasable lock 122 may engage with a sloped portion 148 of the shoulder 134 which causes the releasable lock 122 to be released to the unlocked position 150 (see FIG. 11). The shoulder 134 may be configured to slide along the base body 102 until the shoulder 134 contacts the ledge 160 of the base body 102. When the shoulder 134 contacts the ledge 160, the ledge 160 prevents the slider body 104 from moving beyond its intended range in the longitudinal direction 146 toward the second end 154 of the base body 102.

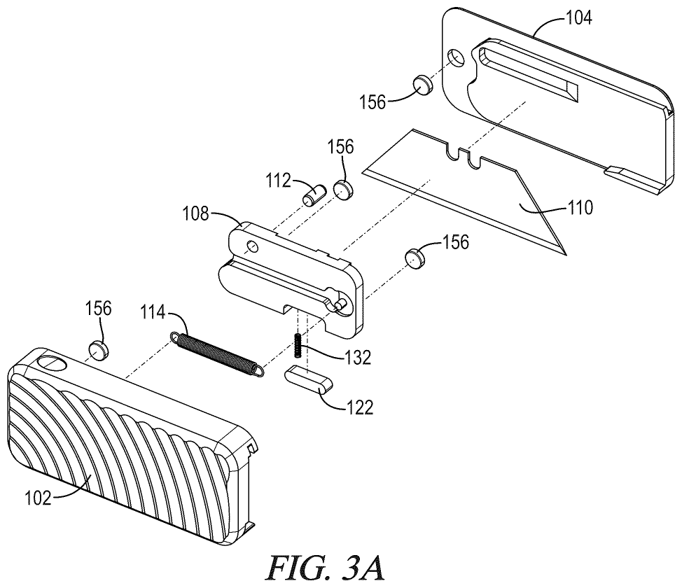

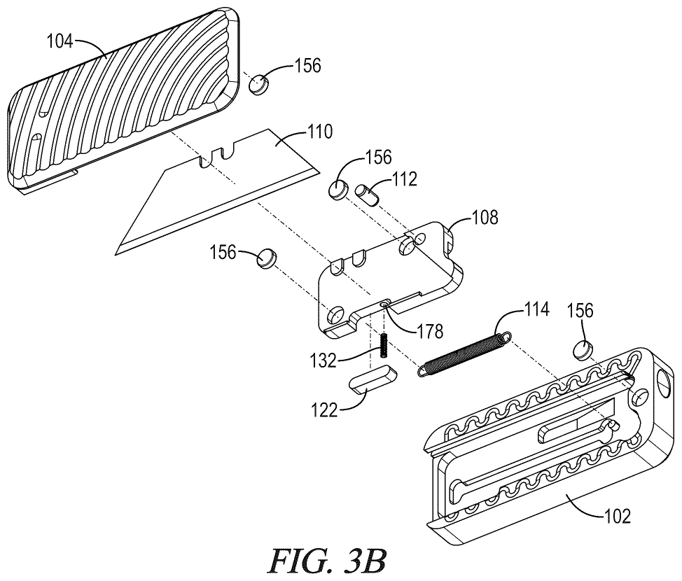

As shown in FIGS. 3A, 3B, and 6-11, the base body 102 and the slider body 104 may utilize magnets 156 or other similar mechanisms for securing the base body 102 and the slider body 104 together in the longitudinal direction 146. These magnets 156 may provide an additional safety factor. For instance, while in the retracted position 120 and in a user's pocket, the magnets 156 may prevent the out-the-front knife 100 from extending or retracting unintentionally and therefore alleviate the potential for accidental cut or stab wounds. Alternatively, while in the extended position 130, the magnets 156 may prevent the slider body 104 from moving in the longitudinal direction 146 toward the second end 154 of the base body 102 and causing the shuttle 108 and the knife blade 110 from retracting unintentionally.

As shown in FIGS. 1A, 2, and 8-11, the out-the-front knife 100 may include a mounting hole 168 or other similar connection method in the base body 102 for attaching a lanyard, chain, or other similar object. The lanyard, chain, or other similar object may provide for additional security and safety.

As shown in FIG. 13, in certain optional embodiments, the cavity 106 may be formed in such a way as to support the shuttle 108 from all six sides and prevent the shuttle 108 and a knife blade 110 from moving in the lateral direction or beyond the intended range in the longitudinal direction 146.

As shown in FIGS. 3-5 and 8-11, the shuttle 108 may be contained within the cavity 106. The shuttle 108 may be configured to carry a knife blade 110. The knife blade 110 may be a standard-type utility blade or the like. In certain optional embodiments, the shuttle 108 may contain a plurality of magnets 156, blade locking extrusions 158, or the like to secure the knife blade 110 to the shuttle 108.

The shuttle pin 112 may be contained within the shuttle 108. The shuttle pin 112 may be configured to selectively engage the base body 102 or the slider body 104. In certain optional embodiments, the shuttle pin 112 may be captured within a shuttle hole 170 in the shuttle 108. The shuttle pin 112 may interact with the base groove 136 or the slider groove 138 located within the base body 102 and the slider body 104. The interaction of the shuttle pin 112 and the slider cam 142 may prevent the slider body 104 from overextending in the longitudinal direction 146 toward the first end 152 of the base body 102. This may be accomplished due to the shuttle pin 112 being contained within the shuttle 108 and being prevented from moving in the longitudinal direction 146 toward the first end 152 of the base body 102 or the second end 154 of the base body 102. When the shuttle pin 112 engages with the slide cam 142, the shuttle pin 112 is biased toward the slider body 104 and more particularly, the slider groove 138. Once the shuttle pin 112 is engaged with the slider groove 138, slider body 104 may not extend in the longitudinal direction 146 toward the first end 152 of the base body 102 due to the shuttle pin's 112 engagement with the slider groove 138. The shuttle pin 112 may be configured to move freely in the lateral direction while being supported by the shuttle hole 170 in the shuttle 108. The shuttle pin 112 may be cylindrical in shape or the like.

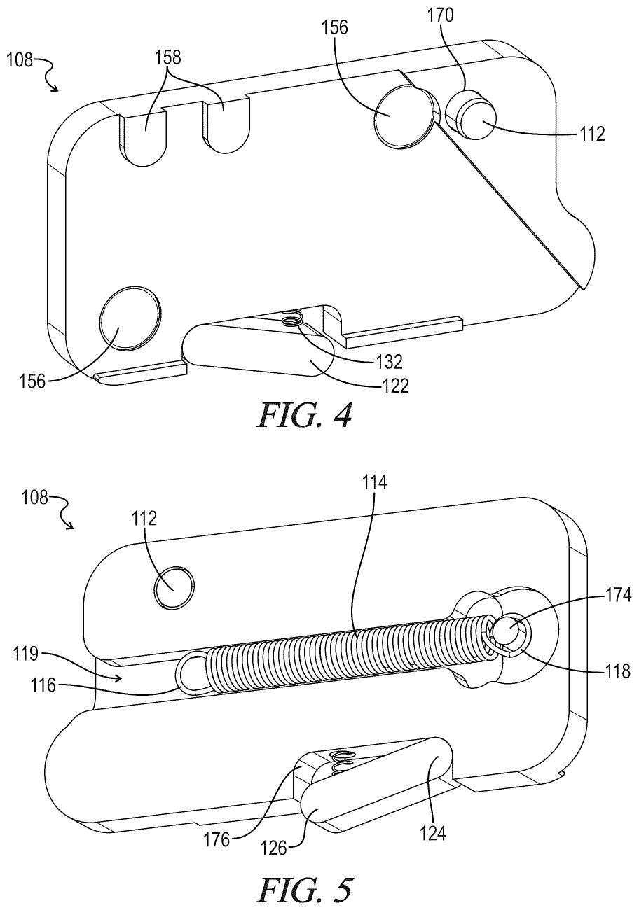

As shown in FIGS. 4, 10, and 11, the shuttle pin 112 may be captured within the shuttle hole 170. The magnet 156 may be configured to bias the shuttle pin 112 toward a wall of the shuttle hole 170 so that a slight frictional force is applied to the shuttle pin 112 thus preventing the shuttle pin 112 from moving unintentionally. In other optional embodiments, the shuttle 108 may include a spring or the like (not shown) configured to bias the shuttle pin 112 toward a wall of the shuttle hole 170 so that a slight frictional force is applied to the shuttle pin 112 thus preventing the shuttle pin 112 from moving unintentionally. In some optional embodiments, the spring or the like (not shown) may be captured within the shuttle 108 and bias the shuttle pin 112 toward the wall of the shuttle hole 170. In other optional embodiments, the spring or the like (not shown) may be captured within the shuttle pin 112 and bias the wall of the shuttle hole 170.

The out-the-front knife 100 may include the shuttle spring 114 that may have a first shuttle spring end 116 and a second shuttle spring end 118. The first shuttle spring end 116 may be connected to the base body 102 and the second shuttle spring end 118 may be connected to the shuttle 108. The base body 102 may include a base shuttle spring mount 172 that the first shuttle spring end 116 is fixed to. The shuttle 108 may include a shuttle spring mount 174 that the second shuttle spring end 118 is fixed to. The shuttle spring 114 may be configured to bias the shuttle 108 toward a retracted position 120 (see FIG. 11). In certain optional embodiments, the shuttle spring 114 may be configured to bias the shuttle 108 in the longitudinal direction 146. The shuttle spring 114 may be a standard-type spring or other similar object capable of applying force in a direction such as a piston.

The out-the-front knife 100 may include the releasable lock 122. The releasable lock 122 may have a first releasable lock end 124 and the second releasable lock end 126. As shown in FIG. 4, the shuttle 108 may contain a notch 176 intended to capture the releasable lock 122. The releasable lock 122 may be constrained between the shuttle 108 and the base body 102. The releasable lock 122 may be configured to selectively engage the base body 102 in a locked position 128 (see FIGS. 8 and 10) of the releasable lock 122 to lock the shuttle 108 in an extended position 130 of the shuttle 108 relative to the base body 102. The releasable lock 122 may be configured to pivot about the first releasable lock end 124. More particularly, the second releasable lock end 126 may be configured to bias into the ledge 160 of the base body 102. The out-the-front knife 100 may include a releasable lock spring 132. The shuttle 108 may contain a releasable lock spring hole 178 configured to house the releasable lock spring 132. The releasable lock spring 132 may be configured to bias the second releasable lock end 126 toward the locked position 128 of the releasable lock 122. The releasable lock spring 132 may be a standard spring or other object capable of applying force in a direction.

The base groove 136 may have a base cam 140 located toward the retracted position 120 of the shuttle 108. In other optional embodiments, the slider groove 138 may have a slider cam 142 located toward the extended position 130 of the shuttle 108. The base cam 140 and the slider cam 142 may be configured to selectively bias the shuttle pin 112 toward the slider body 104 or the base body 102, respectively, to allow the shuttle pin 112 to engage either the slider body 104 or the base body 102 and allow the shuttle 108 to be extended or retracted, respectively.

In certain optional embodiments, the slider body 104 may be configured to engage with the shuttle pin 112 to move the shuttle 108 to an extended position 130. The slider body 104 may engage with the releasable lock 122 which would cause the second releasable lock end 126 to move toward the shuttle 108 and compress the releasable lock spring 132 and allow the shuttle 108 to move toward the retracted position 120.

Referring now to FIGS. 1, 9, and 11, an embodiment of the present disclosure is depicted in the retracted position 120. In the retracted position 120, the shuttle 108 is moved in the longitudinal direction 146 toward the second end 154 of the base body 102 until the shuttle 108 is prevented from moving further in the longitudinal direction 146 toward the second end 154 of the base body 102 by the base body 102. The shuttle spring 114 is in a relaxed state, albeit slightly under tension to maintain its connection to the base body 102 and the shuttle 108. In this position, the second releasable lock end 126 is biased toward the shuttle 108 such that the shuttle 108 is free to move in the longitudinal direction 146 toward the second end 154 of the base body 102. The shuttle pin 112 is biased toward the slider body 104 and, more specifically, the slider groove 138 by the base cam 140.

Referring now to FIGS. 2, 8, and 10, an embodiment of the present disclosure is depicted in the extended position 130. In the extended position 130, the shuttle 108 is moved in the longitudinal direction 146 toward the first end 152 of the base body 102 until the shuttle 108 is prevented from moving further in the longitudinal direction 146 toward the first end 152 of the base body 108 by the base body 102. The shuttle spring 114 is placed under tension by the base body 102 and the shuttle 108. In this position, the second releasable lock end 126 is biased into the ledge 160 of the base body 102 by the releasable lock spring 132. Specifically, the second releasable lock end 126 is biased into the ledge 160. With the second releasable lock end 126 biased into the ledge 160, the shuttle 108 is prevented from retracting under the pressure from the tensioned shuttle spring 114. With the second releasable lock end 126 biased into the ledge 160 of the base body 102, the out-the-front knife 100 may be able to withstand significant force applied in the longitudinal direction 146 toward the second end 154 of the base body 102.

Referring to FIG. 1B, an embodiment of the present disclosure is illustrated. The longitudinal direction 146 may be defined as the lengthwise direction along the longest side of the out-the-front knife 100. The lateral direction 180 may be defined as the widthwise direction through the thickness of the out-the-front knife 100. The first end 152 of the base body 102 may be defined as the end of the base body 102 that the knife blade 110 extends from when in the extended position 130. Alternatively, the first end 152 of the base body 102 may be defined as the end of the base body 102 that is configured to accept the slider body 104. The second end 154 of the base body 102 may be defined as the end opposite the first end 152 of the base body 102.

The shuttle 108 and knife blade 110 may be extended and retracted. To extend the knife blade 110, the slider body 104 may be slid in the longitudinal direction 146 relative to the base body 102 toward the first end 152 of the base body 102. During this motion, the shuttle pin 112 engages the slider body 104 and moves the shuttle 108 in the longitudinal direction 146 with the slider body 104. In this embodiment, the shuttle 108 may be carrying the knife blade 110. As the base body 102 and the shuttle 108 move in the longitudinal direction 146 toward the first end 152 of the base body 102, the releasable lock 122, which is constrained between the shuttle 108 and the base body 102 is biased by the releasable lock spring 132 toward the base body 102. More particularly, the releasable lock spring 132 is biased into the ledge 160 of the base body 102. The releasable lock 122 is now in the locked position 128. Accordingly, the shuttle 108 likewise is locked in the extended position 130.

To retract the knife blade 110 from the extended position 130, the slider body 104 is slid toward the second end 154 of the base body 102. This movement causes the shoulder 134 to engage with the releasable lock 122. More particularly, the shoulder 134 engages with the second releasable lock end 126. By engaging the shoulder 134, the second releasable lock end 126 is biased toward the shuttle 108. This movement causes the releasable lock spring 132 to be compressed into the shuttle 108. Once the releasable lock spring 132 is compressed into the shuttle 108, the releasable lock 122 is moved to the unlocked position 150. The shuttle 108 may then be biased toward the slider body 104 with the shuttle spring 114 causing the shuttle 108 and, in some embodiments, the knife blade 110 to be retracted.

Sliding the slider body 104 toward the first end 152 of the base body 102 may tension the shuttle spring 114. The first shuttle spring end 116 may be fixed to base shuttle spring mount 172. The base body 102 may include a base channel 115 that the shuttle spring 114 may be contained within. The second shuttle spring end 118 may be fixed to the shuttle spring mount 174. The shuttle 108 may include a shuttle channel 119 that the shuttle spring 114 may be contained within that is colinear with the base channel 115. The shuttle spring 114 may be a standard spring or other object capable of biasing the shuttle 108 in the longitudinal direction 146 toward the second end 154 of the base body 102.

In certain optional embodiments, the releasable lock spring 132 and the releasable lock 122 may be combined into one mechanism that performs the same or similar functionality. For instance, the releasable lock 122 may itself be some form of spring or other object capable of extending into the ledge 160 of the base body 102 retracting toward the shuttle 108 upon engagement with the shoulder 134.

In certain optional embodiments, the knife blade 110 may be replaceable. To remove the knife blade 110 captured within the shuttle 108, the slider body 104 may be slid in a first direction relative to the base body 102 toward the first end 152 of the base body 102. As described in more detail above, this movement moves the shuttle 108 and the knife blade 110 to the extended position 130. Next, the slider body 104 may be slid in a second direction relative to the base body 102 while the knife blade 110 is prevented from retracting. This may cause the shuttle pin 112 to disengage from the slider body 104. The slider body 104 may then be slid in the first direction relative to the base body 102 toward the first end 152 of the base body 102 until the slider body 104 is free from the base body 102. The knife blade 110 may then be removed and replaced.

To reattach the slider body 104 to the base body 102, the slider body 104 may be reengaged to the base body 102 and slid in the second direction relative to the base body 102. The slider body 104 may be slid in the second direction relative to the base body 102 until the shoulder 134 engages with the releasable lock 122 and releases the releasable lock 122 to the unlocked position thereby releasing the shuttle 108 carrying the knife blade 110 into the retracted position. This movement causes the shuttle pin 112 to reengage the slider body 104 which prevents the slider body 104 from disengaging from the base body 102.

In certain optional embodiments, when the knife blade 110 is prevented from retracting, the releasable lock 122 may be prevented from disengaging the base body 102. With the knife blade 110 in the extended position 130, a user may prevent the knife blade 110 from retracting by grasping the knife blade 110 while simultaneously sliding the slider body 104 in the longitudinal direction 146 toward the second end 154 of the base body 102. The shoulder 134 will engage the second releasable lock end 126 which normally would release the shuttle 108 from the extended position 130. More particularly, the sloped portion 148 of the shoulder 134 will engage the second releasable lock end 126 and bias the second releasable lock end 126 toward the shuttle 108. However, since the knife blade 110 is being prevented from retracting, the second releasable lock end 126 merely biases toward the shuttle 108 without any movement from the shuttle 108. During this operation, the shuttle pin 112 in engaged with the slider groove 138. Upon movement of the slider body 104 in the longitudinal direction 146 toward the second end 154 of the base body 102, the shuttle pin 112 contacts the slider cam 142 and is biased toward the base body 102 and out of the slider cam 142, effectively disengaging the shuttle pin 112 from the slider body 104. Movement of the shuttle pin 112 in this manner allows the slider body 104 to move unrestricted in the longitudinal direction 146 toward the first end 152 of the base body 102. The slider body 104 may then be removed from the base body 102 by sliding the slider body 104 in the longitudinal direction 146 toward the first end 152 of the base body 102 until the slider body 104 is no longer in contact with the base body 102.

In certain optional embodiments, when the out-the-front knife 100 is in the retracted position 120, the shuttle pin 112 is engaged with the base cam 140 so that the shuttle pin 112 is biased toward the slider body 104 and, more specifically, is engaged with the slider groove 138. In this position, when the slider body 104 is slid in the first direction relative to the base body 102, the shuttle pin 112 may engage the slider body 104 via the slider groove 138 and move the shuttle 108 carrying the knife blade 110 toward the first end 152 of the base body 102. This movement allows the releasable lock 122 to be released to the locked position 128 engaged with the ledge 160. At this point, the shuttle pin 112 is still engaged with the slider groove 138.

Thus, it is seen that the device of the present disclosure readily achieves the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A knife, comprising:
a base body and a slider body defining a cavity therebetween, the base body slidably connected to the slider body;
a shuttle contained within the cavity and configured to carry a knife blade;
a shuttle pin contained within the shuttle, the shuttle pin configured to selectively engage the base body or the slider body;
a shuttle spring having a first shuttle spring end and a second shuttle spring end, the first shuttle spring end connected to the base body and the second shuttle spring end connected to the shuttle, the shuttle spring configured to bias the shuttle toward a retracted position;
a releasable lock having a first releasable lock end and a second releasable lock end, the releasable lock constrained between the shuttle and the base body, the releasable lock configured to selectively engage the base body in a locked position of the releasable lock to lock the shuttle in an extended position of the shuttle relative to the base body;
a releasable lock spring configured to bias the second releasable lock end toward the locked position of the releasable lock; and
a shoulder extending from the slider body configured to engage the releasable lock upon retraction of the slider body to release the releasable lock so that the shuttle may move to the retracted position relative to the base body.

2. The knife of claim 1, wherein the shuttle spring is configured to bias the shuttle in a longitudinal direction.

3. The knife of claim 1, wherein the releasable lock is configured to pivot about the first releasable lock end.

4. The knife of claim 1, wherein the base body contains a base groove and the slider body contains a slider groove, the base groove and the slider groove configured to selectively engage the shuttle pin to selectively move the shuttle toward the extended position or the retracted position.

5. The knife of claim 4, wherein the base groove has a base cam located toward the retracted position of the shuttle and the slider groove has a slider cam located toward the extended position of the shuttle, the base cam and the slider cam being configured to selectively bias the shuttle pin toward the slider body or the base body, respectively, to allow the shuttle pin to engage either the slider body or the base body and allow the shuttle to be extended or retracted, respectively.

6. The knife of claim 1, wherein the slider body is configured to engage with the shuttle pin to move the shuttle to an extended position, and the slider body engages with the releasable lock, causing the second releasable lock end to move toward the shuttle and compress the releasable lock spring to allow the shuttle to move toward the retracted position.

7. The knife of claim 1, wherein the shuttle contains a plurality of magnets and at least one of the plurality of magnets is configured to bias the shuttle pin toward a wall of a shuttle hole.

8. A method of extending and retracting a knife blade, comprising the steps of:
sliding a slider body relative to a base body in a longitudinal direction toward a first end of the base body;
engaging the slider body with a shuttle pin and moving a shuttle carrying the knife blade in the longitudinal direction with the slider body;
releasing a releasable lock constrained between the shuttle and the base body to a locked position and locking the shuttle and the knife blade in an extended position;
sliding the slider body toward a second end of the base body;
engaging the releasable lock with a shoulder of the slider body; and
biasing the shuttle toward the second end of the base body with a shuttle spring to retract the shuttle and the knife blade.

9. The method of claim 8, wherein sliding the slider body toward the first end of the base body includes tensioning the shuttle spring.

10. The method of claim 8, further comprising capturing the shuttle pin within the shuttle and restricting the slider body from over extending in the longitudinal direction.

11. The method of claim 8, further comprising biasing the releasable lock toward the base body with a releasable spring housed within the shuttle.

12. The method of claim 8, further comprising engaging the releasable lock with a sloped portion of the shoulder to release the releasable lock to an unlocked position.

13. A method of removing and replacing a knife blade, comprising the steps of:
capturing the knife blade within a shuttle;
sliding a slider body in a first direction relative to a base body to move the shuttle and the knife blade to an extended position;
sliding the slider body in a second direction relative to the base body while preventing the knife blade from retracting thus causing a shuttle pin to disengage the slider body and engage the base body;
sliding the slider body in the first direction relative to the base body until the slider body is free from the base body;
removing and replacing the knife blade;
reengaging the slider body and the base body;
sliding the reengaged slider body in the second direction relative to the base body; and
retracting the knife blade.

14. The method of claim 13, further comprising securing the knife blade to the shuttle using a plurality of magnets or extrusions.

15. The method of claim 13, wherein preventing the knife blade from retracting includes preventing a releasable lock from disengaging the base body.

16. The method of claim 13, further comprising retracting the knife blade and biasing the shuttle pin toward a slider groove of the slider body.

17. The method of claim 13, wherein sliding the slider body in the first direction relative to the base body includes engaging the shuttle pin and the slider body causing the shuttle to move toward a first end of the base body and releasing a releasable lock to a locked position.

18. The method of claim 13, wherein retracting the knife blade includes sliding the slider body in the second direction and engaging a shoulder of the slider body with a releasable lock so that the releasable lock is moved to an unlocked position.
